(19) United States
(12) Patent Application Publication
(10) Pub. No.: US 2015/0276099 A1
(43) Pub. Date: Oct. 1, 2015

(54) PIPE CONNECTOR APPARATUS

(71) Applicant: Eric Weissmann, San Juan Capistrano, CA (US)

(72) Inventor: Eric Weissmann, San Juan Capistrano, CA (US)

(21) Appl. No.: 14/666,279

(22) Filed: Mar. 23, 2015

Related U.S. Application Data
(63) Continuation-in-part of application No. 13/602,309, filed on Sep. 3, 2012.
(60) Provisional application No. 61/968,509, filed on Mar. 21, 2014.

(51) Int. Cl. F16L 13/11; F16L 43/00; F16L 21/03; F16L 15/04; F16L 21/00; F16L 21/08

(52) U.S. Cl. CPC F16L 13/11; F16L 21/002; F16L 21/08; F16L 21/03; F16L 15/04; F16L 43/00

(57) ABSTRACT

An apparatus is disclosed for connecting piping sections of a pipe fitting or pipe. The apparatus includes a housing having first and second inlets for receiving a piping section, and a first and a second aperture disposed on the housing and configured to open into an axially recessed portion of the apparatus sized and adapted for receiving an epoxy from which to secure the piping sections.

### CROSS REFERENCE TO RELATED APPLICATIONS

This application is a continuation-in-part of U.S. application Ser. No. 13/602,309 filed on Sep. 3, 2012 and a nonprovisional patent application of 61/968,509 filed Mar. 21, 2014. Each patent application identified above is hereby incorporated herein by reference in its entirety to provide continuity of disclosure.

### TECHNICAL FIELD

This disclosure relates to pipe connections, and more particularly to connecting pipes with an epoxy.

### BACKGROUND

The statements in this section merely provide background information related to the present disclosure and may not constitute prior art.

Fittings or connectors for the connection of sections of pipes are known in a number of design types. Perhaps the simplest form of pipe connector is a sleeve for connecting two pipes together. The sleeve may fit around an end of each pipe and be sealed in position to effectively make the two pipes one. This type of connection fitting is often practiced in domestic plumbing, where the sleeve is usually formed of copper and soldered onto copper pipes.

More complex connectors tend to rely on some kind of compression fit. For example, a sleeve may be fitted onto the end of a pipe that squeezes around the outside of the pipe to form a seal. Often, a sealing component, such as an O-ring seal, is provided between the pipe and the sleeve. This type of seal is used in some more modern domestic plumbing systems and is often referred to as a “press-fit” or “push-fit” connector. In known push-fit type connectors typically a mechanical locking element ensures that a pipe section maintains a position with respect to the pipe to which it is joined. It is desirable to prevent the pipe from changing its position, which may occur due to rotational or lateral movement relative of the pipe section due to internal or external forces, to prevent the pipe from decoupling.

It can be appreciated that certain stresses and forces act upon the fitting during use. Certain types of pipe may also inherently shrink and expand under environmental conditions. In particular, if a connector is fitted to a pipe that subsequently expands the stress the connector applies to the pipe will increase, which may lead to the seal between the connector and pipe breaking or the pipe distorting around the O-ring. These connectors also tend to have multiple additional components, which can make them prone to break or wear out.

Therefore, there exists a need to increase the durability of the connection seal.

### SUMMARY

An apparatus is disclosed for connecting piping sections of a pipe fitting or pipe. The apparatus includes a housing having first and second inlets for receiving a piping section, and a first and a second aperture disposed on the housing and configured to open into an axially recessed portion of the apparatus sized and adapted for receiving an epoxy from which to secure the piping sections.

Various embodiments may include O-rings for further coupling piping sections.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows a side view of a pipe connector, in accordance with the present disclosure;

FIG. 2 shows a side view of a pipe connector connecting a first and second piping section, in accordance with the present disclosure;

FIG. 3 shows a cross-sectional view of a pipe connector, in accordance with the present disclosure;

FIG. 4 shows a cross-sectional view of an additional embodiment of the pipe connector, in accordance with the present disclosure;

FIG. 5 shows a cross-sectional view of an embodiment of the pipe connector with pipe sections connected, in accordance with the present disclosure;

FIG. 6 shows a cross-sectional view of an embodiment of the pipe connector depicting a further embodiment of a pipe connection means, in accordance with the present disclosure;

FIG. 7 shows a cross-sectional view of an embodiment of the pipe connector depicted in FIG. 6 with the connection means engaging a pipe, in accordance with the present disclosure;

FIGS. 8A-8D show a further embodiments of the pipe connector apparatus, in accordance with the present disclosure;

FIGS. 9A and 9B show a further embodiment of the pipe connector apparatus, in accordance with the present disclosure;

FIGS. 10A and 10B show an embodiment of the pipe connector having O-rings, in accordance with the present disclosure; and

FIGS. 11A-11F show various exemplary embodiments of a pipe connector that may utilize the teachings herein, in accordance with the present disclosure.

### DETAILED DESCRIPTION

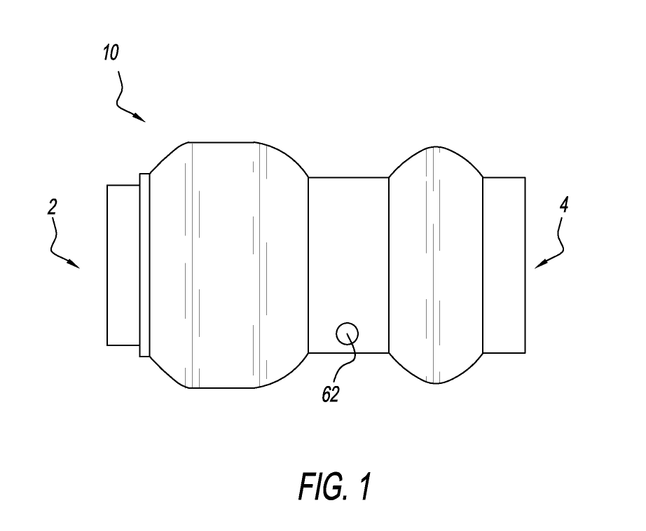

Referring now to the drawings, wherein the depictions are for the purpose of illustrating certain exemplary embodiments only and not for the purpose of limiting the same, FIG. 1 shows a side view of a pipe connector 10. The pipe connector 10 includes first and second receiving ends 2 and 4, respectively. The receiving ends may be adapted to receive various pipes and fittings and the disclosure herein is therefore not intended to be limited thereby. In one embodiment, the receiving ends may be threaded. Although in the preferred embodiment, the first end 2 is configured to receive a pipe or fitting having the same outside diameter as the second end 4, the pipe connector 10 may be configured to receive different sized pipes as will be readily apparent to one skilled in the art.

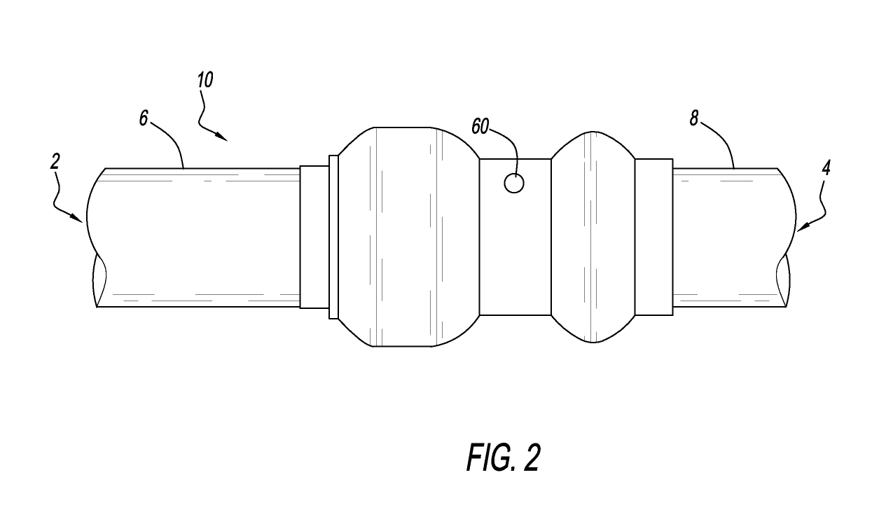

FIG. 2 shows a side view of a pipe connector 10 connecting a first and second piping section 6 and 8, respectively. In the preferred embodiment, the pipe connector 10 is formed of metal and is intended to receive copper piping, although other materials may be used for the pipe connector 10 and for the piping or other fittings to be connected. For example, the piping received by the at least one inlet and outlet of the pipe connector 10 are preferably copper, but may also be CTS, PVC or CPVC. The pipe connector 10 may also be used with pipe or tubing of polybutylene or PeX (cross-linked polyethylene) but the use of PeX tubing may require the use of an adapter which is provided within the PeX tubing to stiffen the end of the PeX tubing received by the pipe connector 10. The adapter comprises an annular ring which has an outside diameter corresponding to the inside diameter of the uncompressed PeX tubing. The adapter prevents the PeX tubing from being unduly compressed by teeth of the press-fit connection arrangement.

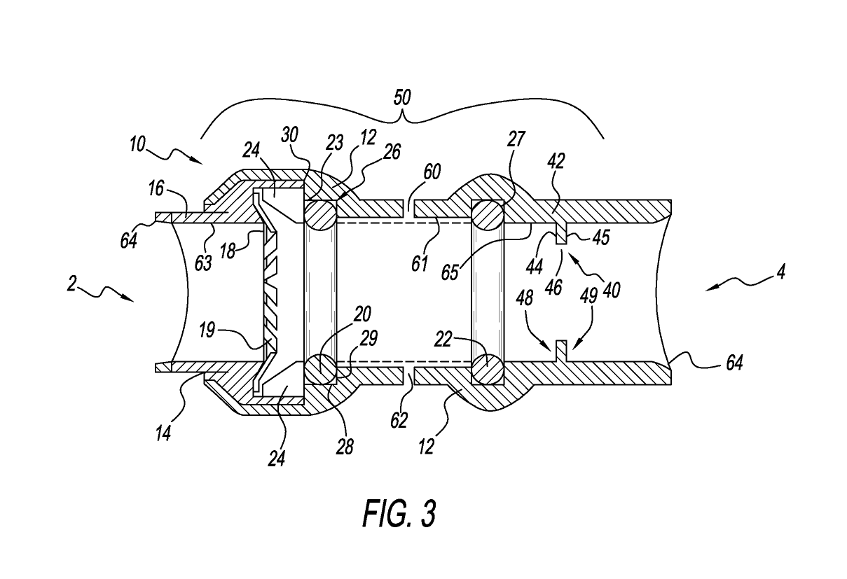

FIG. 3 shows a cross-sectional view of the pipe connector 10. The pipe connector 10 includes a push-fit connection arrangement 50 having a first component 12 and a second component 14, which are generally cylindrical in shape. The second component 14 is preferably threaded into the first component 12, however, various known coupling processes may be applied and the disclosure herein is therefore not intended to be limited thereby. The receiving ends 2 and 4 of the pipe connector 10 which are positioned axially preferably have tapered ends 64 so as to facilitate insertion of a pipe end or fitting into the pipe connector 10. In this way, the tapered ends 64 act as a guide to direct the pipe end or fitting into the pipe connector 10.

The second component 14 may include a release collar 16 configured to selectively engage a piping engaging member 18, i.e., a teeth ring or a split grab-ring. The release collar 16 is in coaxial alignment with the piping engaging member 18. The second component 14 may have an inner diameter which is slightly larger than an outside diameter of the pipe or fitting to be received. The second component 14 is preferably formed as to be threaded into the first component 12 to maintain the piping engaging member 18 in position on an annular shoulder 30.

The piping engaging member 18 includes a plurality of individual teeth 19 pointed generally inwardly toward first and second sealing members 20 and 22, respectively. In the preferred embodiment, the sealing members are O-rings but other suitable sealing members could be used in place of the O-ring. For example, an annular lip seal, or gasket. The teeth 19 have a generally flat end so as to securely grip an outer surface of a pipe or fitting without piercing or damaging the outer pipe surface. The piping engaging member 18 is preferably formed of spring steel but other materials may be used for the piping engaging member 18 depending upon the composition of the pipe or other fitting to be received by the piping engaging member 18. The piping engaging member 18 is directed radially inwardly and toward the first and second O-rings 20 and 22 preferably forming a series of generally V-shaped segments so as to form the individual teeth 19. A sealant may be applied to the piping engaging member 18 and interior surface areas of the second component 14 to permanently affix the piping engaging member 18 within the pipe connector 10.

The first component 12 includes a shoulder 30 that abuts an outermost portion of the second component 14 and thereby limits the position of the second component 14 relative to the piping engaging member 18. In this way, the second component 14 creates a receiving space for the piping engaging member 18. In addition, the portion of the second component 14 that abuts the first component 12 has a corresponding cross section so as to direct the teeth radially inwardly and generally toward the O-rings 20 and 22. The axially innermost portion of the second component 14 also prevents the teeth 19 from bending away from the O-rings 20 and 22, i.e., if the pipe or fitting is being pulled out of the pipe connector 10. The shoulder 30 is further adapted to receive an O-ring protector component 24, axially positioned within the second component 14 to abut the first O-ring 20. The O-ring protector 24 is configured to hold the first O-ring 20 in position within an O-ring shoulder 26.

The O-ring shoulder 26 has a diameter along an axial surface 28 which is slightly less than the cross-sectional diameter of the O-ring 20 so that the O-ring 20 will be compressed when the pipe or fitting is received within the pipe connector 10. The O-ring shoulder 26 also has an annular, radial surface 29 which has a width which is slightly less than the diameter of the O-ring 20 again so that the O-ring 20 is compressed when the pipe connector 10 receives the pipe or fitting. The shoulder 26 and the O-ring protector component 24 form a recess 23 for containing the first O-ring 20. A second recess 27 is formed to contain the second O-ring 22.

A pipe stop 40 is formed to position a first pipe and a second pipe within the pipe connector 10. The pipe stop 40 forms a first and second piping shoulder 48 and 49, respectively, to receive the first and second pipes or pipe fittings. The piping shoulders 48 and 49 have a diameter along an axial surface 42 which corresponds to and is slightly larger than an outside diameter of a pipe or tubing to be connected to the pipe connector 10. The first piping shoulder 48 has an annular, radial surface 44 which limits axial movement of the pipe or tubing when engaged by the pipe connector 10. The second piping shoulder 49 has an annular, radial surface 45 which limits axial movement of the pipe or tubing when engaged by the pipe connector 10. The pipe stop 40 is preferably a protrusion defined by the radial surfaces 44 and 45 and a top surface 46. The top surface 46 preferably protrudes at least as a width of an inserted pipe and is preferably flush with an interior surface thereof. For example, the pipe stop 40 is configured to receive a pipe or fitting having the same inside diameter as the top surface 46 and preferably the same annular-shape.

Between the O-rings 20 and 22, first and second holes, i.e., inlets 60 and 62, respectively, are disposed from a surface of the pipe connector 10 to the interior. The first inlet 60 is preferably larger than the second inlet 62. The first and second inlets 60 and 62 are configured to enable a user to insert a sealant suitable as a pipe adhesive such as an epoxy into the pipe connector 10 as described herein below. In one preferred embodiment, the first inlet 60 is configured to receive the sealant, while the second inlet 62 is configured to view the sealant within the pipe connector 10. To enable a user to view the epoxy, but inhibit sealant from exiting the pipe connector 10, the second inlet 62 is preferably configured with a smaller opening than the inlet size of the first inlet 60. In one embodiment, the size of the second inlet 62 may be adapted for a particular sealant to advantageously apply surface tension properties, i.e., the opening is configured to be large enough to view the sealant, but configured size constrained to inhibit leakage.

Interior walls of the pipe connector 10 are sized to receive piping and fitting. The pipe connector 10 has an interior diameter along an axial surface 63 and 65 to correspond to an exterior diameter of a pipe or fitting. A second axial surface 61 includes a diameter formed to create a space or cavity between the pipe or fitting section and the second axial surface 61. The diameter of the second axial surface 61 is preferably greater than the diameter associated with the axial surfaces 63 and 65. In this way, a user may inject sealant through the opening 60 and into a cavity space as described herein below.

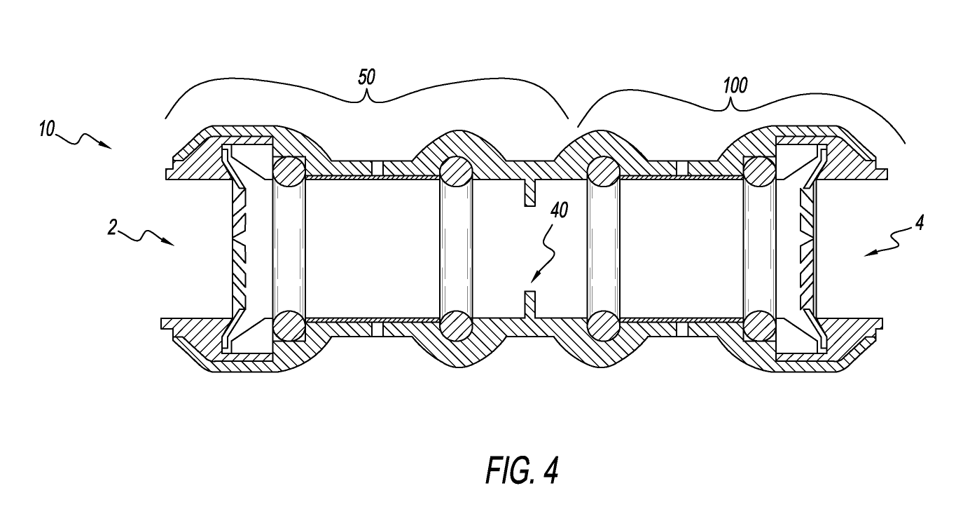

FIG. 4 shows a cross-sectional view of an additional embodiment of the pipe connector 10 having a second push-fit connection arrangement 100. The second push-fit connection arrangement 100 is a mirror structure of the first push-fit connection arrangement 50 described herein above. The second push-fit connection arrangement 100 is configured to receive a second piping section and engage the piping section in a push-fit type coupling. As described herein above, the pipe stop 40 is configured to abut the pipe or pipe fittings within the pipe connector 10. As FIG. 4 shows, the pipe stop 40 will abut inserted pipes or pipe fittings upon the first push-fit connection arrangement 50 receiving a first piping component and the second push-fit connection arrangement 100 receiving a second piping component.

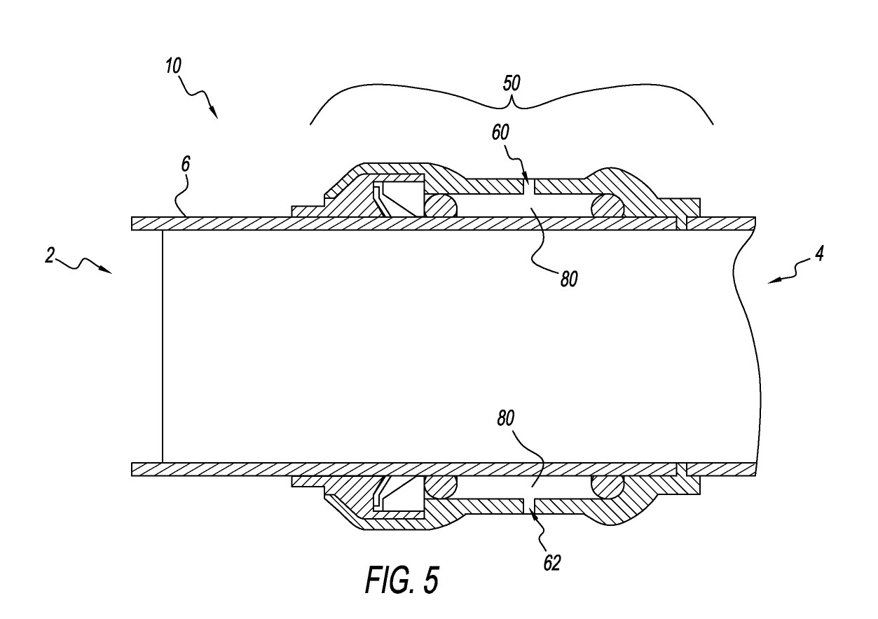

FIG. 5 shows a cross-sectional view of an embodiment of the pipe connector 10 with the exemplary piping section 6 and 8 connected therein. As FIG. 5 shows, an exemplary piping section 6 is inserted into the first end 2 of the pipe connector 10 and the second piping section 8 is inserted into the second end 4. The O-rings 20 and 22 are compressed when receiving the piping section 6. The first piping section 6 is engaged by the first push-fit connection arrangement 50 as described herein above. Subsequent to insertion of the first piping section 6, a user may inject a sealant 80 into the pipe connector 10. The sealant 80 flows around the piping section 6 into the recesses 23 and 27 of the first and second O-rings 20 and 22. In this way, the sealant fortifies the fitting of the piping section 6 against the O-rings 20 and 22 creating a more durable and long-lasting fit.

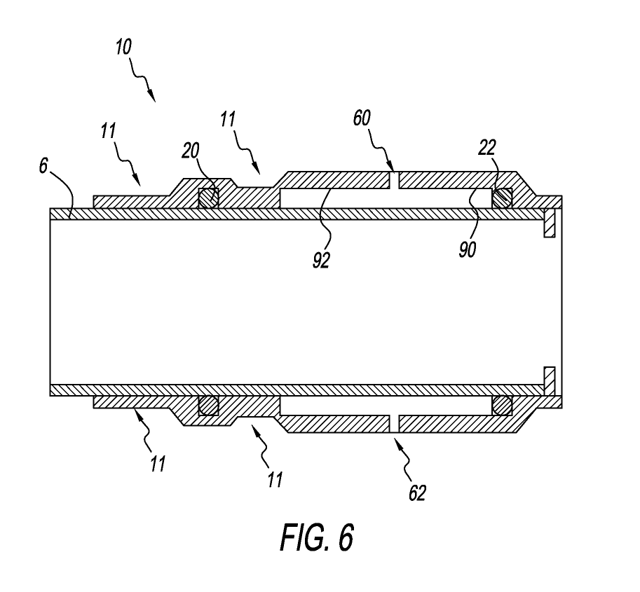

FIG. 6 shows a cross-sectional view of a crimp fitting embodiment of the pipe connector 10 having a piping section 6 inserted within. The pipe connector 10 includes a connection means having a surface 11 configured to crimp into a piping section when pressed by tool. In a preferred crimp fitting embodiment, at least one O-ring is configured to crimp into a piping section and at least one O-ring is configured to receive a sealant. As FIG. 6 shows, the pipe connector 10 has an interior diameter along an axial surface 92 to correspond to an exterior diameter of a pipe or fitting. A second axial surface 60 includes a diameter formed to create a space or cavity between the pipe or fitting section and the second axial surface 90. The diameter of the second axial surface 90 is preferably greater than the diameter associated with the axial surface 92. In this way, a user may inject sealant through the opening 60 and into a cavity space as described herein above. The cavity space is positioned within the pipe connector 10 to include an O-ring 22, leaving at least one O-ring such as O-ring 20 without a cavity space for sealant injections.

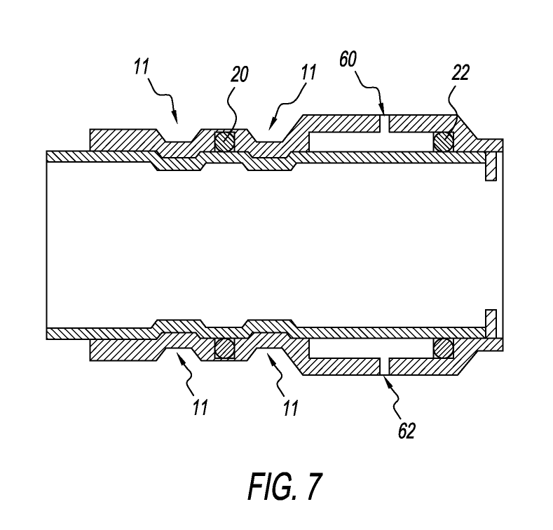

FIG. 7 shows a cross-sectional view of an embodiment of the pipe connector 10 depicted in FIG. 6 with the connection means engaging a pipe. As FIG. 7 shows, the surfaces 11 are crimped into the piping section 6, securing the piping section 6 within the pipe connector 10. One skilled in the art will readily recognize that the pipe connector 10 as depicted in FIGS. 6 and 7 may additionally include multiple additional O-rings including both crimping connection means and sealant connection means.

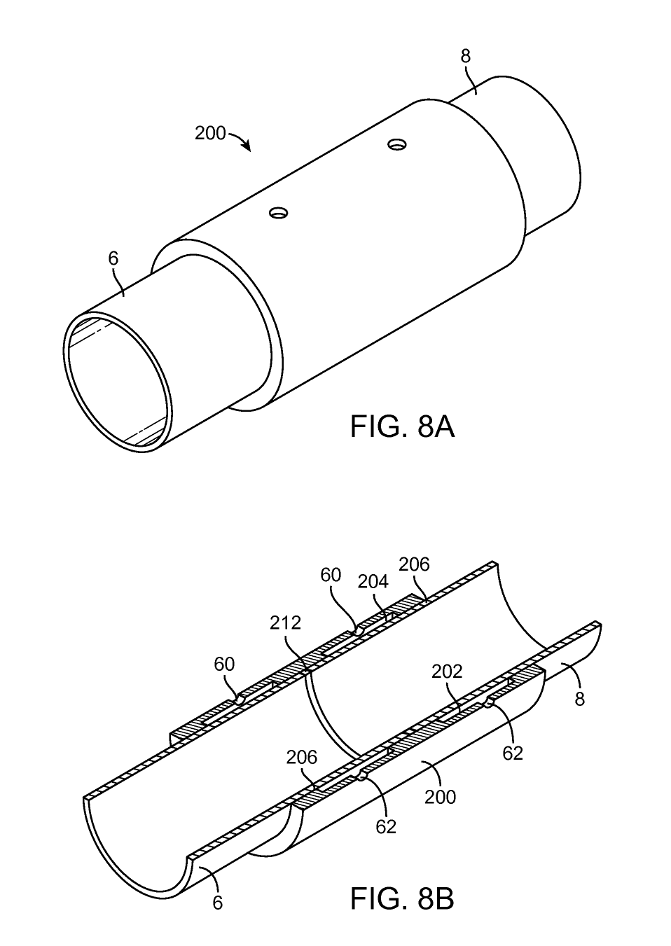

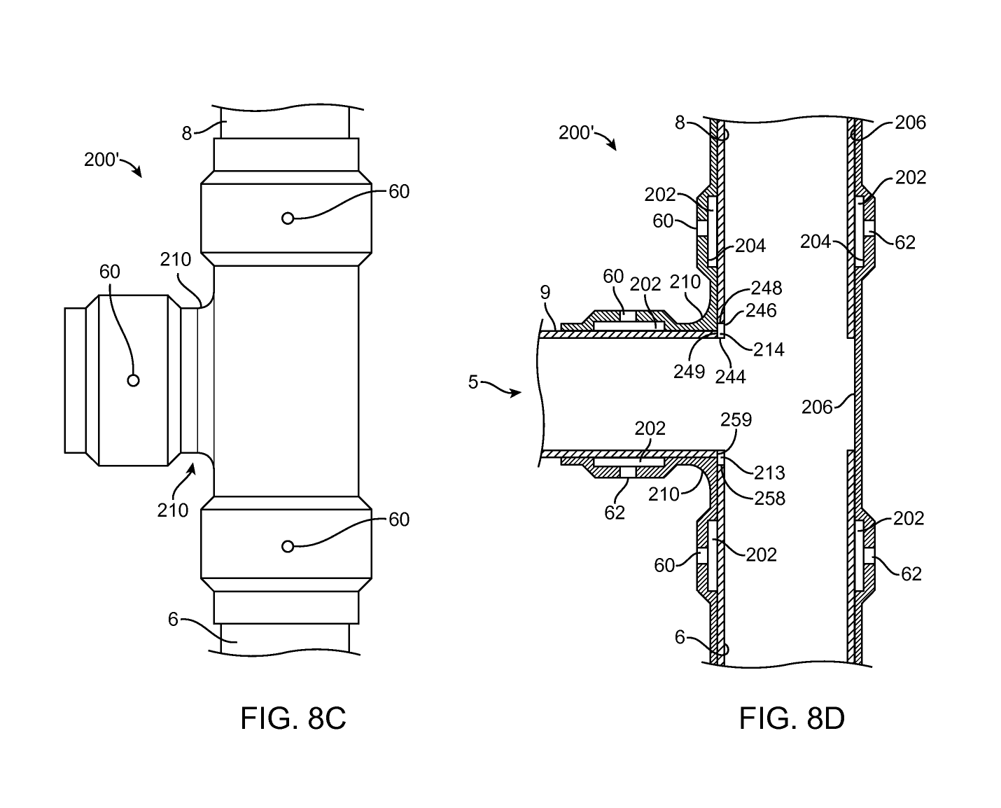

FIGS. 8A-8D show a further embodiment of the pipe connector apparatus. FIGS. 8A and 8B show an embodiment configured to join a first pipe 6 and a second pipe 8, while FIGS. 8C and 8D show an embodiment 200′ configured to join a first, second, and third pipe 6, 8, and 9. The connector 200 includes an interior surface having axially recessed portion 202 formed by an interior axial surface 204 having a diameter greater than a diameter of a first axial surface 206, wherein the first 60 and second apertures 62 open into the axially recessed portion 202. In one embodiment, the first 60 and second apertures 62 open into a central portion of the axially recessed portion 202 such as shown in FIG. 8B. When a piping section is inserted into the coupler, the axially recessed portion 202 forms a hollow cylinder, having a circular, perpendicular cross-section. The axially recessed portion 202 is a void space having dimensions of a hollow cylinder with the addition of the first and second apertures. The embodiment of FIGS. 8C and 8D may additionally include gussets 210 for supporting a third end 5 for receiving the third pipe 9 at a perpendicular intersection.

With reference to FIG. 8D, a stop 213 and 214 are included within an interior region of the pipe connector. The stop 213 and 214 are formed to each abut against received pipes. The stop 213 abuts received pipe 6 and 9, while the stop 214 abuts pipe pipes 8 and 9.

The stop 213 is formed with a first shoulder 258 to abut a received pipe 6 and a second shoulder 259 to abut a received pipe 9. The first shoulder 258 and the second shoulder 259 have a perpendicular cross-sectional relationship. The piping shoulder 258 has an annular, radial surface 258 which limits axial movement of the pipe or tubing when engaged by the pipe connector. Similarly, the stop 214 is formed with a first shoulder 258 to abut a received pipe 8 and a second shoulder 249 to abut a received pipe 9. The first shoulder 248 and the second shoulder 249 have a perpendicular cross-sectional relationship. The piping shoulder 248 has an annular, radial surface 248 which limits axial movement of the pipe or tubing when engaged by the pipe connector.

The pipe stop 214 is preferably a protrusion defined by the radial surfaces of the shoulder 248 and 249 and top surfaces 244 and 246. The top surfaces 244 and 246 preferably protrudes from an interior surface 206 by at least a width of an expected inserted pipe and is preferably flush with an interior surface thereof. For example, the pipe stop 214 is configured to receive a pipe or fitting having the same inside diameter as the top surfaces 244 or 246 and preferably the same annular-shape. Pipe stop 213 is similarly formed having shoulders 258 and 259.

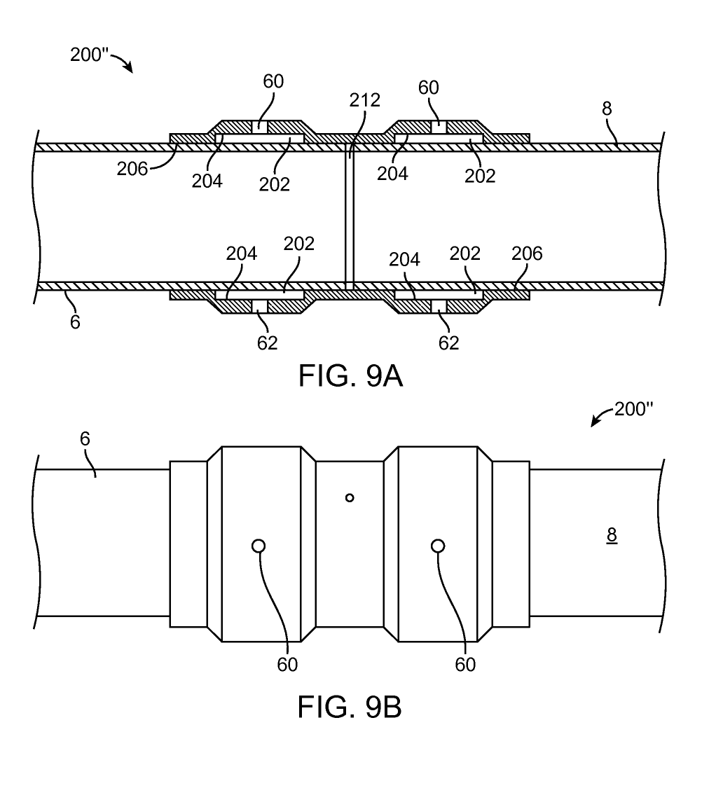

FIGS. 9A and 9B show a further embodiment of the pipe connector apparatus 200″. As FIGS. 9A and 9B show, the apparatus 200″ may be formed as a protrusion from a pipe member 6 and 8. In this way, the void space 202 sits above the pipe 6 and 8 away from an end. In various embodiments the piping apparatus includes a pipe stop 212. The pipe stop 212 is formed to position a first pipe and a second pipe within the connector. The pipe stop 212 forms a first and second piping shoulder, to receive the first and second pipes or pipe fittings. The piping shoulders have a diameter along an axial surface which corresponds to and is slightly larger than an outside diameter of a pipe or tubing to be connected to the pipe connector 10. The first piping shoulder has an annular, radial surface which limits axial movement of the pipe or tubing when engaged by the pipe connector. The second piping shoulder has an annular, radial surface which limits axial movement of the pipe or tubing when engaged by the pipe connector. The pipe stop 212 is preferably a protrusion defined by the radial surfaces and a top surface. The top surface preferably protrudes at least as a width of an inserted pipe and is preferably flush with an interior surface thereof. For example, the pipe stop 212 is configured to receive a pipe or fitting having the same inside diameter as the top surface and preferably the same annular-shape.

In one embodiment as shown in exemplary FIGS. 8A-8D, a straight outside appearance may be utilized. In one embodiment as illustrated in exemplary FIGS. 9A and 9B, an exterior is raised to form the axially recessed interior portions for epoxy.

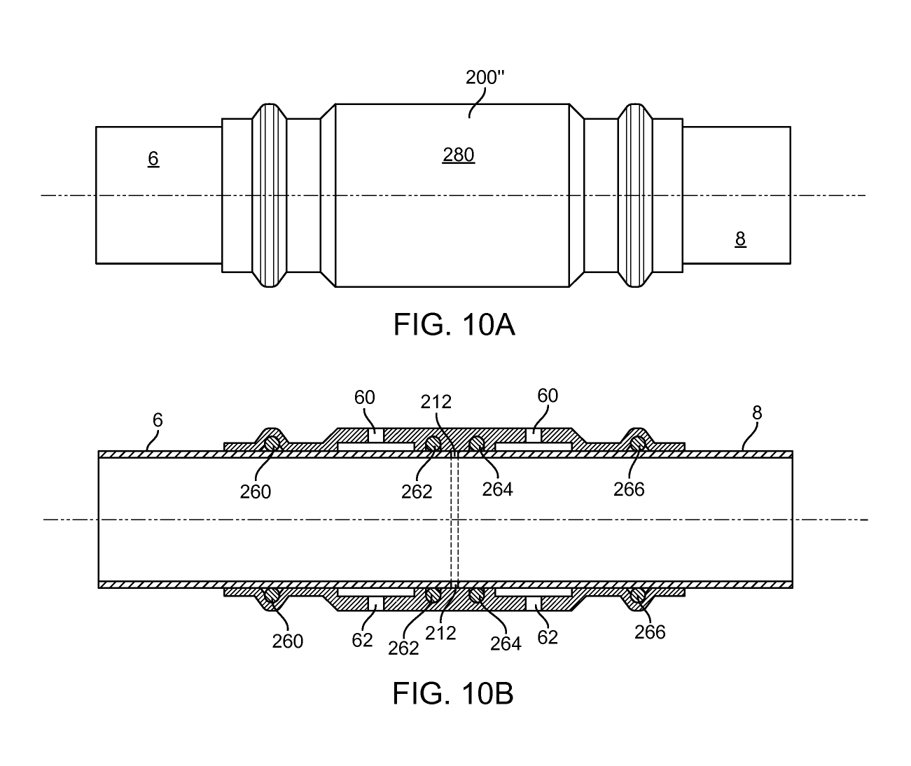

FIGS. 10A and 10B show an embodiment of the pipe connector 200″ having O-rings 260, 262, 264, and 266 and with the exemplary piping section 6 and 8 connected therein. The O-rings are similarly situated as O-ring 20 shown in FIGS. 6 and 7. The pipe connector 200″ includes a housing 280 substantially straight.

The O-rings 260 and 262 are compressed when receiving the piping section 6. Subsequent to insertion of the first piping section 6, a user may inject a sealant into the pipe connector via the opening 60. The sealant flows around the piping section 6 into the axially recessed portion 202. In this way, the sealant supplements the fitting of the piping section 6 against the O-rings 260 and 262 creating a more durable and long-lasting fit. O-rings 264 and 264 act similarly to piping section 8.

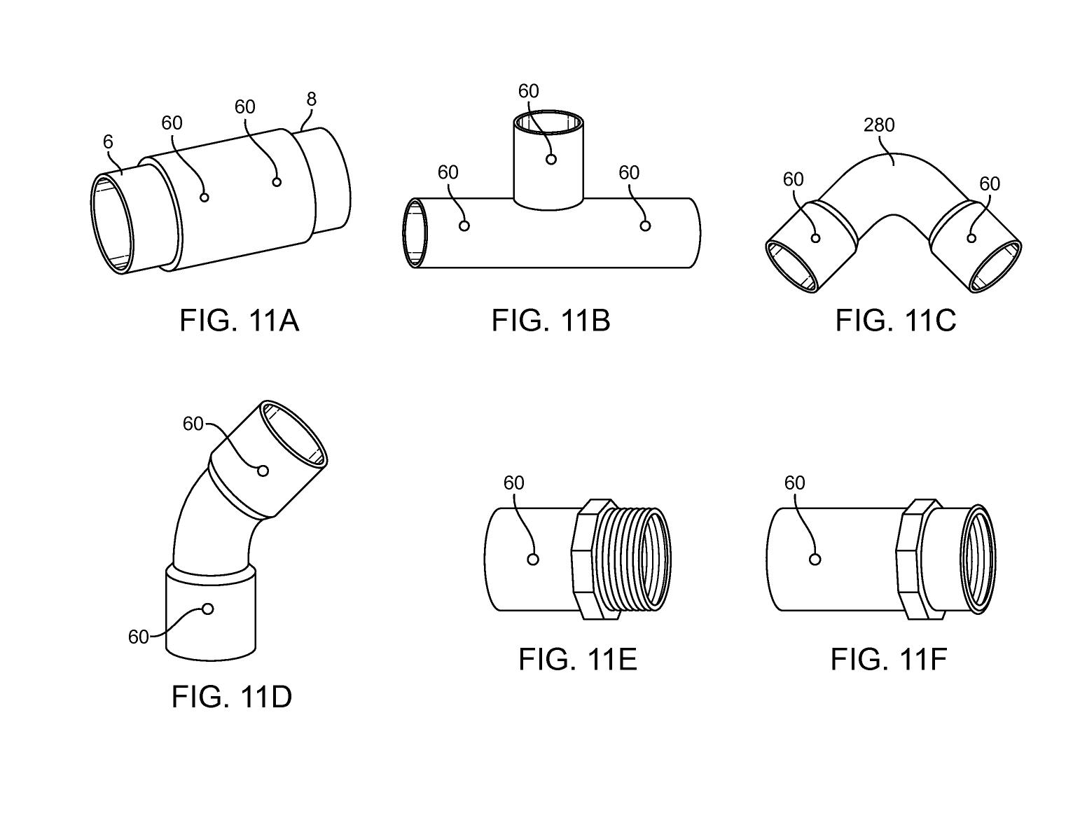

FIGS. 11A-11F show various embodiments of a pipe connector 200 having inlets 60 and axially recessed portions for receiving an epoxy therein. The pipe connectors 200 can be formed for receiving and coupling a wide variety of types and sizes of piping sections. Some sizes are ½″, ¾″, 1″, 1¼″ 1½, 2″, 2¼″, 2½ up to 8″ or more. As illustrated in exemplary FIGS. 11A-11F, the teachings herein may be applied to a wide variety of piping connectors including standard coupling connectors, tee connectors, angled connectors having angled housings 280, male adapter connectors, female adapter connectors, bell reducers, and end caps. One embodiment can include special interior fittings: e.g., 90× fitting and bell reducer ¾ or ½× fitting.

In use, to seal or join pipes, the pipe connector is coupled to various piping sections and then a sealant is applied such as epoxy via the inlets 60. In one embodiment, sealant is added or squeezed into the fitting through the provided entry point. A pipe fitter can add sealant until visual identification of sealant leak or exit from the other end aperture, e.g., outlet 62. In one embodiment, the apertures, inlet and outlet, are provided at a 180-degree difference. In this way, the pipe fitter make insert sealant until the sealant has internally encapsulated the pipes to be fitted.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. An apparatus, comprising:
a housing comprising a first and second inlets for receiving a piping section, the first and second inlets formed by an interior axial surface having a first diameter;
a first and a second aperture formed by the housing, wherein the first and second aperture are substantially diametrically opposed;
an axially recessed portion formed by an interior axial surface having a second diameter greater than the first diameter;
wherein the first and second apertures open into the interior axial surface of the axially recessed portion having the second diameter; and
wherein the axially recess portion is a void space having a volume of a hollow cylinder after receiving a piping section.

2. The apparatus of claim 1, further comprising: a pipe stop integrally formed with the housing.

3. The apparatus of claim 2, wherein the axially recessed portion is sized to receive a sealant.

4. The apparatus of claim 3, further comprising an axially recessed O-ring fluidly removed from the axially recessed portion so as to not receive a sealant.

5. The apparatus of claim 4, wherein the housing is angled.

6. The apparatus of claim 4, wherein the first inlet includes threads for threadably receiving a piping section.

7. A piping connector apparatus, comprising:
a housing comprising a first and second inlets for receiving a piping section, the first and second inlets formed by an interior axial surface having a first diameter;
a first and a second aperture formed by the housing, wherein the first and second aperture are substantially diametrically opposed;
a first axially recessed portion formed by an interior axial surface having a second diameter greater than the first diameter;
wherein the first and second apertures open into the interior axial surface of the axially recessed portion having the second diameter;
a second axially recessed portion formed by an interior axial surface having a same diameter as the first axially recessed portion;
a third and a fourth aperture formed by the housing, wherein the third and a fourth are substantially diametrically opposed, and wherein the third and a fourth open into the interior axial surface of the second axially recessed portion; and
wherein the first and second axially recess portions are a void spaces each having a dimension of a hollow cylinder after receiving a piping section.

8. The apparatus of claim 7, further comprising: a pipe stop integrally formed with the housing.

9. The apparatus of claim 8, wherein the axially recessed portion is sized to receive a sealant.

10. The apparatus of claim 9, further comprising an axially recessed O-ring fluidly removed from the axially recessed portion so as to not receive a sealant.

11. The apparatus of claim 10, wherein the housing is angled.

12. The apparatus of claim 10, wherein the first inlet includes threads for threadably receiving a piping section.

13. A piping connector apparatus, comprising:
a housing comprising a first, second, and third inlets for receiving a piping section, the first, second, and third inlets formed by an interior axial surface having a first diameter, wherein the third inlet is substantially perpendicular to the first and second inlet;
a first and a second aperture formed by the housing, wherein the first and second aperture are substantially diametrically opposed;
a first axially recessed portion formed by an interior axial surface having a second diameter greater than the first diameter;
wherein the first and second apertures open into the interior axial surface of the axially recessed portion having the second diameter;
a second axially recessed portion formed by an interior axial surface having a same diameter as the first axially recessed portion;
a third and a fourth aperture formed by the housing, wherein the third and a fourth are substantially diametrically opposed, and wherein the third and a fourth open into the interior axial surface of the second axially recessed portion;
a third axially recessed portion formed by an interior axial surface having a same diameter as the first axially recessed portion, wherein the third axially recessed portion includes a fifth and sixth aperture formed by the housing, wherein the fifth and sixth are substantially diametrically opposed, and wherein the fifth and sixth open into the interior axial surface of the third axially recessed portion;
wherein the first and second axially recess portions are a void spaces each having a dimension of a hollow cylinder after receiving a piping section.

14. The apparatus of claim 13, further comprising:
a first pipe stop integrally formed within the housing having a first shoulder for abutting a first piping section and a second shoulder for abutting a second piping section, and a second pipe stop integrally formed within the housing having a first shoulder for abutting the first piping section and a second shoulder for abutting a third piping section; and
wherein the first and second pipe stops are defined by a single annular disc positioned to extend passed a first annular interior surface and a second annular interior surface having a 90-degree difference from the first annular interior surface.

15. The apparatus of claim 13, further comprising:
a first pipe stop integrally formed within the housing having a first shoulder for abutting a first piping section and a second shoulder for abutting a second piping section, and a second pipe stop integrally formed within the housing having a first shoulder for abutting the first piping section and a second shoulder for abutting a third piping section; and
wherein the first and second pipe stops are defined by a single protrusion extending in a first axial direction and a second axial direction having a 90-degree difference from the first from interior axial surfaces therein, and wherein the protrusion is further defined by a first end surface sized to be flush with a received piping section from the first inlet, a second end surface sized to be flush with a received piping section from the second inlet, and a third end surface sized to be flush with a received piping section from the third inlet.

16. The apparatus of claim 15, wherein the axially recessed portion is sized to receive a sealant.

17. The apparatus of claim 16, further comprising an axially recessed O-ring fluidly removed from the axially recessed portion so as to not receive a sealant.

18. The apparatus of claim 17, wherein the housing is angled.

19. The apparatus of claim 18, wherein the first inlet includes threads for threadably receiving a piping section.

20. The apparatus of claim 18, wherein the first inlet includes a cap.
